(19) United States
(12) Patent Application Publication
(10) Pub. No.: US 2026/0281206 A1
(43) Pub. Date: Sep. 17, 2026

(54) PEER-TO-PEER LOAD BALANCING FOR FAAS IN AGENTIC AI SYSTEMS

(71) Applicant: NEC Laboratories America, Inc., Princeton, NJ (US)

(72) Inventors: Giuseppe Coviello, Robbinsvillle, NJ (US); Kunal Rao, Monroe, NJ (US); Mohammad Khojastepour, Lawrenceville, NJ (US); Srimat Chakradhar, Manalapan, NJ (US)

(21) Appl. No.: 19/560,651

(22) Filed: Mar. 9, 2026

Related U.S. Application Data
(60) Provisional application No. 63/772,429, filed on Mar. 14, 2025.

(51) Int. Cl. H04L 67/61; G06Q 10/0631; H04L 67/02

(52) U.S. Cl. CPC H04L 67/61; G06Q 10/06316; H04L 67/02

(57) ABSTRACT

Systems and methods for peer-to-peer load balancing. The systems and methods include prompting a model to develop a workflow, the workflow including a set of component operations that can be executed as more than one request on more than one pod and queueing the more than one request for execution on the more than one pod. The systems and methods further include comparing a first pod request queue with a second pod request queue, and in response to the comparison, transferring one of the more than one request from a first pod request queue to a second pod request queue and executing the more than one request.

### RELATED APPLICATION INFORMATION

This application claims priority to U.S. Provisional Patent App. No. 63/772,429, filed on March 14, 2025, incorporated herein by reference in its entirety.

### BACKGROUND

### Technical Field

The present invention relates to agentic artificial intelligence systems and more particularly, load-balancing techniques for agentic AI workflows employing a function-as-a-service (FaaS) model.

### Description of the Related Art

Several workload balancing solutions have been developed, but these workload balancing solutions have flaws. Round-robin type load balancing, which distributes requests evenly across available function-serving pods, does not account for real-time load imbalance. Least-loaded load balancing, which assigns requests to the node with the fewest active tasks, reacts slowly to load bursts which lead to temporary overloads. Queue-aware load balancing, which assigns requests based on real-time queue states (rather than estimated latencies), has not been effectively integrated into FaaS-based agentic AI systems, can include state queue metrics, and can have queues oscillate in length from overcompensation (e.g., from very short to very long). Randomized load balancing and power-of-two-choices, which improve resource utilization, do not account for real-time queue lengths at execution nodes.

Peak Exponential Weighted Moving Average (Peak-EWMA), which solves several of the problems of other solutions by dynamically routing requests based on latency, struggles when function execution times fluctuate significantly, relies on client-side latency as a metric, requires a sidecar proxy, and relies on third-party implementations. The drawbacks of Peak-EWMA can lead to misallocation of functions; can require additional computing processing unit (CPU) overhead and memory overhead; and can be difficult to integrate with standalone FaaS environments.

### SUMMARY

According to an aspect of the present invention, a method is provided for prompting a model to develop a workflow, the workflow including a set of component operations that can be executed as more than one request on more than one pod and queueing the more than one request for execution on the more than one pod. The method further includes comparing a first pod request queue with a second pod request queue, and in response to the comparison, transferring one of the more than one request from a first pod request queue to a second pod request queue and executing the more than one request.

According to another aspect of the present invention, a system is provided for a processor and a memory storing computer-readable instructions. The instructions, when executed, cause the processor to prompt a model to develop a workflow, the workflow includes a set of component operations that can be executed as more than one request on more than one pod and queue the more than one request for execution on the more than one pod. The instructions can cause the processor to compare a first pod request queue with a second pod request queue, and in response to the comparison, transferring one of the more than one request from a first pod request queue to a second pod request queue and execute the more than one request.

According to another aspect of the present invention, computer program product is provided. The computer program code when executed by one or more processors causes the one or more processors to perform operations. The computer program code includes instructions to prompt a model to develop a workflow, the workflow includes a set of component operations that can be executed as more than one request on more than one pod and queue the more than one request for execution on the more than one pod. The computer program code further includes instructions to compare a first pod request queue with a second pod request queue, and in response to the comparison, transferring one of the more than one request from a first pod request queue to a second pod request queue and execute the more than one request.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system for queueing requests to pods, in accordance with an embodiment of the present invention;

FIGS. 2 and 3 are flow diagrams illustrating algorithms for determining request ordering and peer-to-peer pod load balancing, in accordance with an embodiment of the present invention;

FIG. 4 is a block diagram illustrating peer-to-peer load balancing, in accordance with an embodiment of the present invention;

FIG. 5 is a flow diagram illustrating a method for performing peer-to-peer load balancing, in accordance with an embodiment of the present invention; and

FIG. 6 is a block diagram of a system for executing peer-to-peer load balancing, in accordance with an embodiment of the present invention.

### DETAILED DESCRIPTION OF PREFERRED EMBODIMENTS

Load-balancing aids in the execution of complicated, lengthy, or otherwise complex workflows by adjusting where portions of the code to be executed is processed by hardware. This improves execution of computing tasks by reducing time of execution, reducing computational resources used, and other benefits. Embodiments of the present invention include a peer-to-peer load-balancing mechanism framework that dynamically redistributes function requests based on real-time queue lengths and is orchestrator agnostic, which addresses drawbacks of solutions that are native to a specific orchestrator, are unsophisticated, and are incapable of integrating into other orchestrators, among a litany of other problems.

Agentic artificial intelligence (AI) systems, often powered by Large Language Models (LLMs), have transformed domains such as, e.g., finance, healthcare, and transportation. One way these AI agents have done so is by autonomously planning and executing complex tasks that previously required human developers to both build and integrate. The output of these agentic AI agents can be a workflow that represents an order to complete the complex task(s). By autonomously creating workflows and invoking (e.g., calling) external tools and functions to complete the workflows, run time and execution time can be improved, among other benefits.

An example using a workflow generated from an agentic AI agent can be in the field of insurance, more specifically, automating the processing of insurance claims. AI agents can recognize and incorporate computer vision techniques to detect vehicles in an accident scene, identify vehicles make and model, and assess damage severity; and apply and incorporate natural language processing techniques and LLMs to generate claim document. Each of these steps can involve one or more different AI models, which can be best deployed and integrated together as a Function-as-a-Service (FaaS). The FaaS model allows developers to define functions while infrastructure management (e.g., load balancing) is handled automatically by embodiments of the present invention.

The efficiency of a workflow can be affected by the underlying function execution infrastructure. In other words, while the software/code/business logic can be documented extensively, the execution can be hindered by the actual execution of the business logic (e.g., by hardware or firmware). The business logic can be the desired (end) goal of a user. In other words, business logic can refer to any functionality applied to execute a business process (e.g., user desired goal). A business process can use one or more steps, and these steps can be codified by a developer into “functions” (e.g., Application Programming Interface (API) calls). The functions can form a set of component operations to perform the business logic. In embodiments of the present invention, function A is an example of a codified version of a step/business logic within a business process.

Issues, such as, e.g., high latency and poor load balancing of the workflow, can degrade responsiveness, overall performance, and user experience of business logic. To put this another way, while AI agents are transforming many industries, they can be hampered by poor infrastructure, design, and implementation by inefficient load-balancing which can make their adoption less likely or less widespread. In other words, embodiments of the present invention remove friction and some of the issues related to the implementation of FaaS models developed from agentic AI agents.

Embodiments of the present invention can avoid relying on latency tracking, and by doing so, eliminate sidecar proxy overhead and improve adaptability to workload bursts. Also, embodiments of the present invention can integrate with third-party orchestrators such as, e.g., Kubernetes™, OpenShift™, Cloud Foundry™, etc. Similarly, the load-balancing mechanism operates independently of third-party solutions making the load balancing mechanism deployable in a range of function-as-a-service (FaaS) environments.

In some embodiments of the present invention, one or more advantages can be realized. These advantages include reliance on actual queues, rather than predicted data (e.g., predicted queues), effectively managing workload bursts, etc. Relying on an actual queue can improve reliability and accuracy by accounting for operational factors (e.g., real-world system conditions) that can otherwise be overlooked and accounting for unpredictable events such as e.g., outages and temporary overloads/spikes, among other benefits.

Eliminating the sidecar proxy has many advantages including reducing system complexity by removing auxiliary components, reducing resource utilization like computing and memory usage, improving ability to diagnose, troubleshoot, and solve issues, etc.

Employing a framework that is agnostic to a specific orchestrator has other contemplated benefits such as, e.g., supporting operations across multiple orchestrators; integrating with mixed or brownfield workflows; regulating environments with tooling constraints; supporting long-lived systems and deployment across edge, embedded, on-premises, or legacy infrastructures and providing cleaner system boundaries; facilitating testing and adaptation; reducing the likelihood of extensive rewrites; and improving resilience by limiting cascading failures and facilitating recovery, etc.

Embodiments of the present invention employ a peer-to-peer load-balancing mechanism framework. The framework monitors active request queues in a decentralized manner, allowing function-serving pods to dynamically distribute workload. This reduces client-side overhead, and operates independently of third-party solutions such as, e.g., Kubernetes™, making the framework more scalable and lightweight (among other contemplated benefits). While embodiments of the present invention apply the term “pod(s),” other groupings and layers of computing abstraction are also contemplated such as e.g., servers, virtual machines, containers, etc.

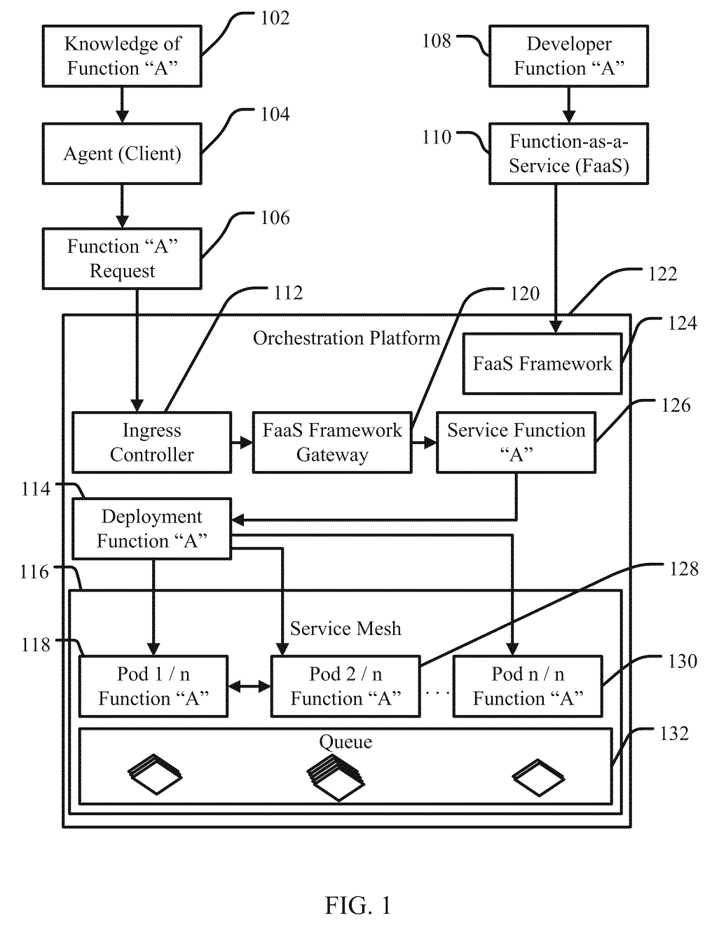

Referring now in detail to the figures in which like numerals represent the same or similar elements and initially to FIG. 1, a block diagram illustrating a peer-to-peer load balancing framework architecture is depicted, in accordance with an embodiment of the present invention. Knowledge of function “A” 102 can include known capabilities that can be represented as function “A”. In other words, knowledge of function “A” 102 can include functions, tasks, operations, programs, calls, etc., that can be performed to complete a desired goal or portion of the desired goal.

The goal can be considered the objective a user requests to be performed by the FaaS model. Function “A” can be include pre-processing tasks such as data ingestion, collection, receiving, and importing; data validation, verification, and schema checking; data cleaning, filtering, deduplication, and error correction; data normalization, standardization, encoding, and transformation; data labeling, annotation, and tagging; and data segmentation, partitioning, and windowing; and data alignment, synchronization, and multimodal association.

Function “A” can also include data analysis such as, e.g., feature extraction; feature selection, weighting, scoring, and ranking; feature normalization, reduction, embedding, aggregation, and fusion; pattern recognition and structure discovery; trend detection and temporal analysis; correlation, dependency, and relationship identification; similarity matching and distance computation; classification and categorization; clustering and grouping; anomaly, outlier, and fault detection; graph, network, or relational structure construction; rule evaluation and constraint satisfaction; hypothesis testing and inference; scoring, ranking, and prioritization of entities; confidence estimation and uncertainty quantification; risk assessment and impact evaluation; prediction, forecasting, and estimation; simulation and scenario modeling; decision support, recommendation, and triggering; adaptive parameter tuning and optimization; etc.

Function “A” can further include post-processing such as, e.g., synthetic data generation; content, document, and report generation; template-based and personalized output generation; summarization, abstraction, and condensation; translation, transcription, and format conversion; result interpretation and explanation generation; attribution, trace, and audit-trail generation; visualization, chart, and dashboard generation; formatting, layout, and presentation generation; alert, notification, and event generation; workflow orchestration and pipeline management; task scheduling and execution control; resource allocation and load balancing; feedback incorporation and model or process updating; versioning, rollback, and configuration management; and outputting, transmitting, storing, and displaying results.

Applying knowledge of function “A” 102, client 104 can form function “A” request 106 which calls for the performance of an operation (a portion of, or the entirety of, user requested business logic). The operation can be a function, call, task, logic, code, etc., that serves a purpose in achieving the desired goals of a user as reflected in function “A” request 106 (e.g., perform the business logic). The representation of function “A” request 106 can be in the form of a natural language or machine language, or some combination thereof. Other types of inputs are also contemplated such as e.g., audio, images, documents, etc.

Client 104 can apply knowledge of function “A” 102 to form function “A” request 106 as well as additional sources such as, e.g., a retrieval augmented generation (RAG) database, fine-tuning, prompt-stuffing/context-injection, employing a search-then-read design, employ knowledge graphs, memory-augmented models, caching, programmatic reasoning, etc., or some combination thereof.

In parallel and/or concurrently with the formation of function “A” request 106, developer function “A” can be implemented to the function “handler” (e.g., FaaS 110) with the desired business logic to form the workflow (also known as the workload). The business logic for an insurance claim FaaS, can be for example, identify the make and model of each car, assess damage, populate a claims report, notify relevant personnel, etc. In some embodiments of the present invention FaaS 110 can be formed at a time that is neither concurrent nor parallel to formation of function “A” request 106.

The workflow can be a set order of operations that are completed to perform the function such as e.g., applying computer vision, scene analysis, text generation, etc., in handling an insurance claim. In some embodiments of the present invention the formation of function “A” request 106 and FaaS 110 do not have to be concurrent or parallel, though in some embodiments of the present invention they are either parallel or concurrent.

The business logic can be sent to FaaS framework 124. Embodiments of the present invention can be used with a third-party FaaS framework 124 such as, e.g., OpenFaaS™, or can be proprietary. FaaS framework 124 can develop and deploy functions in accordance with function “A” request 106. The function can then be deployed on FaaS framework 124, which runs on orchestrator platform 122 (e.g., Kubernetes™) cluster. Orchestrator platform 122 can be from a third-party such as, e.g., Kubernetes™, or proprietary.

When function “A” request 106 is received by orchestrator platform 122, particularly by ingress controller 112, the information is forwarded to FaaS framework gateway 120. The information then identifies the appropriate “Service” object and routes the request to one of the available pods 118, 128, 130. The selected pod then processes the request and returns the response to the agent.

In greater detail, when a function is deployed, FaaS framework 124 can automatically create (on corresponding orchestrator platform 122) one or more “Service” objects (Service function “A” 126), which allow access to the function’s hypertext transfer protocol (HTTP) endpoint (e.g., on port 8080) within the cluster. “Service” objects can expose endpoints/APIs through which a function can be queried from outside the orchestration platform. In other words, a “Service” object can take an input, process the input at an API and send back an output in the response, acting as an interface for the API.

While some technical details can be described using Kubernetes™-specific terminology and tools, other orchestrator platforms 122 and tools serving similar or the same functions are contemplated.

FaaS framework 124 also generates one or more “Deployment” objects for the function (deployment function “A” 114), which manage the life-cycle of the serving instances. The “replicas” value in the Deployment object specifies the number of active function-serving pods 118, 128, 130. This value can be adjusted to accommodate a request load, either dynamically or based on a set of rules or heuristics. After deployment, the function’s metadata, including its purpose, input parameters, and expected outputs, can be registered with service mesh 116. Equipped with this knowledge of the metadata, service mesh 116 can invoke the function as needed to execute specific tasks in a business workflow.

Clusters can be computing processing units (CPUs), graphics processing units (GPUs), tensor processing units (TPUs), neural processing units (NPUs), digital signal processors (DSPs), field-programmable gate arrays (FPGAs), application-specific integrated circuits (ASICs), system-on-a-chip (SoC) devices, microcontrollers, general-purpose processors, specialized processors, hardware accelerators, reconfigurable computing devices, heterogeneous and multi-core processing architectures, distributed processing systems, virtualized processing resources, cloud-based processing resources, edge-based processing resources, etc., and any combinations thereof.

Pods 118, 128, 130 can be part of service mesh 116 which coordinates which pod is the best selection for running a function at a given time, in real time. In some embodiments of the present invention, the selection of a preferred pod can be based on the queue length, though computer hardware such as memory, number of cores/threads, clock speed, instructions per cycle, type of storage, operating system scheduling, concurrency/contention/locking, system load and background tasks, etc., can also be considered. In other words, in embodiments of the present invention there can be optimization for throughput/runtime/execution time or other considerations like computational resources, etc.

Queue 132 can have individual queues for each pod. The shortest individual queue can be selected for a function at a given time, though selection of the individual queue can be based off of several criteria. Embodiments of the present invention can select the shortest queue for a portion of the function, equalizing or more evenly distributing the queue lengths in real-time. The individual queue lengths can be evaluated randomly or according to any number of heuristics. The evaluation can be continuous or at set intervals, which can be marked with timestamps. The evaluation can be for two pods at a time or another number of pods.

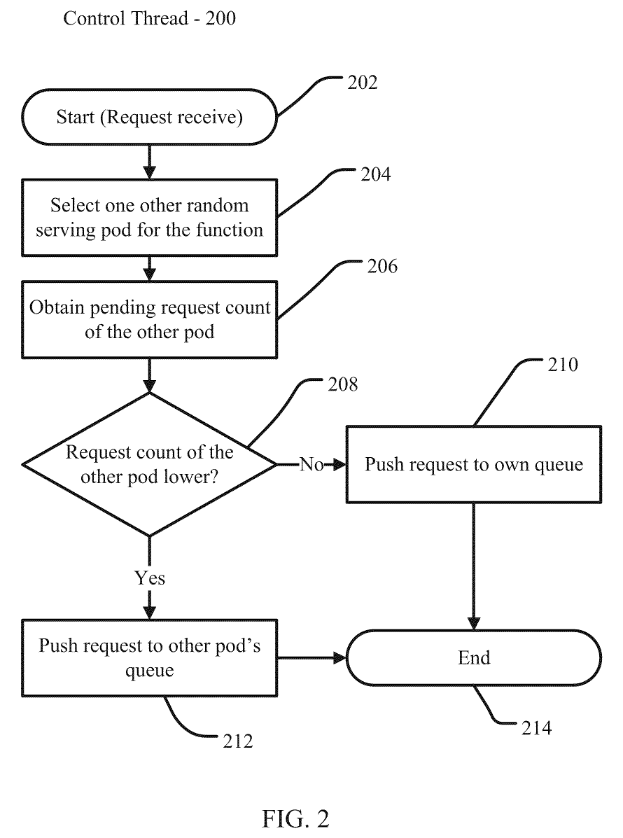

Referring to FIG. 2, an algorithm that can be applied in accordance with embodiments of the present invention is illustratively depicted. The algorithm can be applied to aid in determining whether the current pod is the most appropriate place to perform the operation. When a function request is received 202 by the service object, the request is initially assigned to a randomly selected serving pod. This request is handled by control thread 200 running on that pod, which marks a creation timestamp for the request. As the request waits in the individual queue to be performed by the hardware, the algorithm then selects another randomly chosen serving pod that is handling the same function 204. In alternative embodiments of the present invention, the selection can be pseudo-random or intentional according to any number of heuristics, or combinations thereof. The heuristics that compare pods can include comparing queues based on the uniformity in execution time in the queue, comparing pods based on the speed at which requests in the queue are being serviced, etc. Such intentional heuristics can include e.g. the least recently checked pod queue.

Control thread 200 queries this second pod to retrieve its current number of pending requests 206. If the second pod has a lower queue length than the local pod, the request is forwarded (transferred) to the second pod 212; otherwise, the request remains in the current pod’s queue 210. After this determination is made and the push request is completed for control thread 200 and the algorithms ends 214. The forwarding of the request of the second pod 212 can cause the overall software/code/business logic to be executed with lower execution time, lower latency, higher throughput, etc. In some embodiments of the present invention, the initial selection of a first pod to execute the request can be intentional, rather than random (e.g. at request is received 202).

In alternative embodiments of the present invention, runtime/execution time are not optimized for, and alternatives to timestamps can be employed. For example, in embodiments of the present invention that include batching requests for parallel execution, the batching can be based on the amount of memory, CPU, storage, etc. used to process the request. An optimized batch can potentially reduce the cost of execution, memory used, computing resources used, etc.

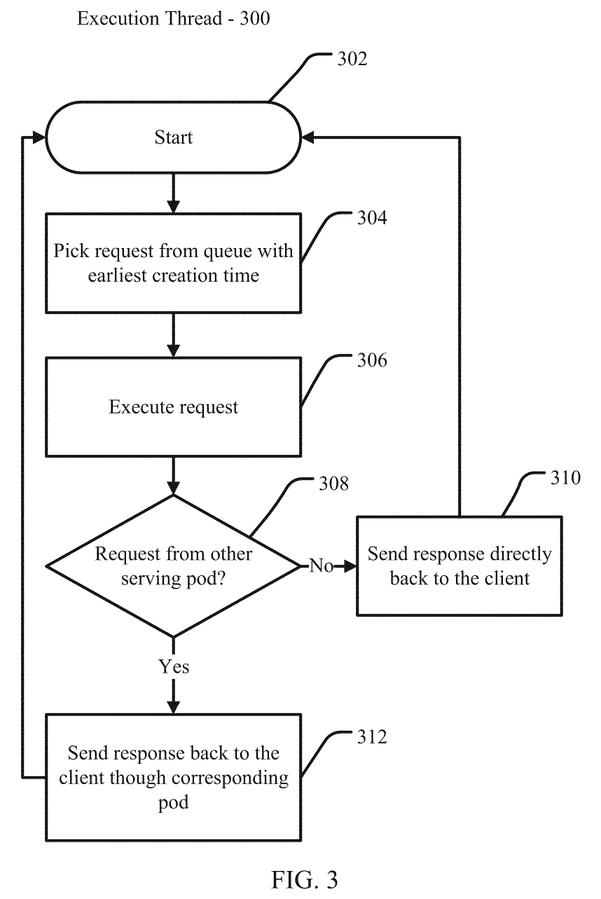

Referring to FIG. 3, another algorithm that can be applied in accordance with embodiments of the present invention is illustratively depicted. The algorithm can be applied to aid in determining whether the current pod is the most appropriate (e.g., optimal) pod to perform the operation. Execution thread 300 can be run concurrently, or at least partially concurrently, with control thread 200. Execution thread 300 can run at each pod and can run continuously on a loop.

At each iteration, execution thread 300 starts 302 by picking the function request with the earliest creation time (assigned by control thread 200) 304 and processes the request 306. After execution, execution thread 300 checks whether the request originated from another pod or from its own control thread 308. If the request was forwarded by another serving pod, the response is relayed back to the pod the response was originally from, which then can relay the information of the request completion to client 312. If the request was executed locally (the original pod), the response is sent to client 310. The response can be a notification or other indication that the request was executed, performed, etc. The response can be HTTP response status codes, other transmission control protocol (TCP) responses, remote procedure call (RPC) responses, etc.

By separating load-balancing logic into control thread 200, which is lightweight, and an execution thread 300, which is independent of control thread 200, embodiments of the present invention achieve efficient request distribution with minimal overhead. Control thread 200 operates with low computational cost, as it tracks queue lengths and redirects requests, when necessary, instead of more complicated and computationally expensive metrics. Meanwhile, execution thread 300 ensures that function requests are processed in a priority-driven manner, selecting requests based on their earliest creation timestamp. Compared to conventional methods, embodiments of the present invention consider real-time queue lengths instead of estimated latencies, adapts better to workloads with high execution time variability, and operates independently of a specific orchestrator platform 122 or agentic AI system, making it suitable for a broader range of FaaS deployments beyond.

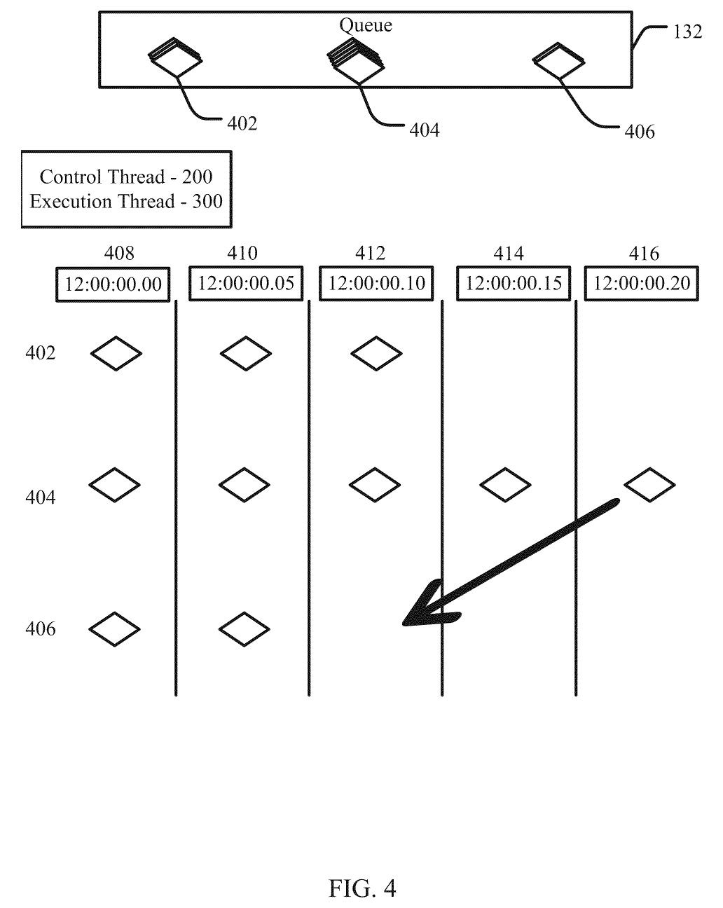

Referring to FIG. 4, queue 132 of FIG. 1 is elaborated on in further detail in accordance with an embodiment of the present invention. In correspondence with pods 118, 128, 130, are individual queues 402, 404, 406, respectively. Individual queue 402 has three requests, in an exemplary embodiment of the present invention but any number of requests is contemplated. Individual queue 404 has five requests. Individual queue 406 has two requests. Control thread 200 can change this distribution in real-time to have a more even distribution. Control thread 200 can assign timestamps to the requests entering the queues, e.g., in intervals of fifty (50) milliseconds. Other time increments such as microseconds, seconds, etc., are contemplated. Control thread 200 can otherwise mark each request as they are received in methods other than timestamps such as e.g., a unique identifier like Universally Unique Identifier (UUID), a sequence number (e.g., a monotonic counter), a logical clock such as, e.g., Lamport clock or vector clock, etc., or some combination thereof.

At timestamp 408, 410, each of the individual queues 402, 404, 406 have requests to execute, so control thread 200 and execution thread 300 avoids changing the order or queueing of requests to improve the workflow.

At timestamp 412, individual queue 406 is blank. This can be for any number of reasons such as, e.g., uneven initial distribution of incoming requests due to hashing, affinity, or probabilistic routing; heterogeneous execution capacity across pods or nodes; variability in request processing time arising from data-dependent operations, cache effects, or external service calls; differences in pod lifecycle or warm-up state; resource contention or throttling of CPU, memory, network, or I/O; backpressure from downstream dependencies such as databases or rate-limited services; transient failures, retries, or timeouts; placement or scheduling effects that influence network latency or node performance; concurrency limits within the pod, such as thread pools or connection caps; and measurement or metrics staleness, including delayed sampling or clock skew; etc. Each of these causes, alone or in combination, can result in observed disparities in queue length even among pods that are otherwise nominally identical.

Control thread 200 can identify that individual queue 406 has a shorter queue than individual queue 404 and move one (or more) request(s) from individual queue 404 to individual queue 406 to make the distribution of requests (more) even/equal. It is also contemplated that a transfer can occur between individual queue 402 and individual queue 406, since individual queue 402 is longer than individual queue 406, even if there is a possibility of no change in overall efficiency.

Execution thread 300 can be running in tandem with control thread 200 to ensure the queue is running in sequential order or close to sequential order. While control thread 200 can ensure the distribution of requests on the pods is even or close to even, execution thread 300 ensures the queues do not go out of turn following a first-in-first-out (FIFO) process, though other processes like last-in-first-out (LIFO) are also contemplated.

At timestamp 408, 410 execution thread 300 can have the requests with timestamps 408, 410 of 12:00:00.00 and 12:00:00.05, respectively, executed before the requests with timestamps 412, 414, 416 of 12:00:00.10, 12:00:00.15, and 12:00:00.20. At timestamp 412, execution thread 300 can ensure the pod corresponding to individual queue 404 executes the request with the timestamp of 12:00:00.10 before the request with the timestamp of 12:00:00.15. Execution thread 300 can also notify individual queue 406 the pod that the request originated from individual queue 404, not individual queue 406, while at the same time notifying individual queue 402 that the request was from that pod originally.

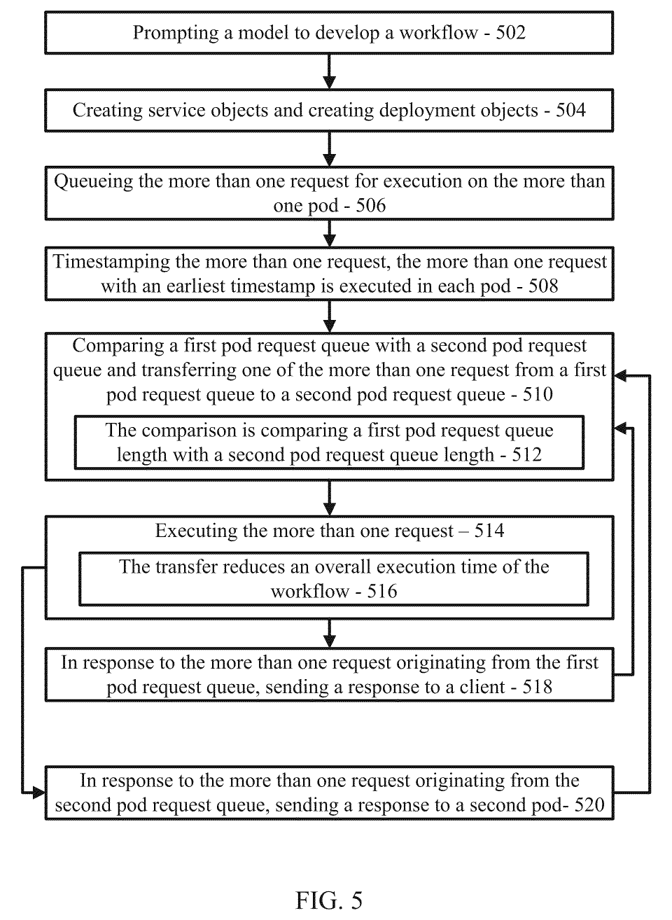

Referring to FIG. 5, a method for peer-to-peer load balancing for FaaS, in accordance with an embodiment of the present invention. Several portions of the method depict optional embodiments of the present invention that can be incorporated into the method in multiple combinations. In other words, none, some, or all optional embodiments of the present invention can be incorporated into the method concurrently. In block 502, a model to develop a workflow is prompted. The workflow includes a set of component operations that can be executed as more than one request on more than one pod. The component operations can be functions, tasks, calls, application programming interface (API) calls, etc. The set of component operations can include one or more the same operation or different operations that are performed while performing the objective set out in the request. The requests can be modular repeatable versions of the component operations. In optional block 504, service objects and deployment objects are created. The service objects allow access to HTTP endpoint of the more than one request. In block 506, the more than one request for execution on the more than one pod are queued. In optional block 508, the more than one request is timestamped the more than one request with an earliest timestamp is executed in each pod. Other markers are also contemplated such as, e.g., sequences such as monotonic counters (local counters, global counters, per-connection counters), logical clocks, vector clocks, versioning/revisions, leases, heartbeats, barriers, epoch-based coordination, causal connections such as e.g., happens-before relationships and dependency graphs, append-only logs, cryptographic chaining, attestations, timeouts and expiration, queue position, priority weights, TCP sequence numbers, flow identifiers, etc.

In block 510, a first pod request queue is compared with a second pod request queue. In response to the comparison, one of the more than one request is transferred from a first pod request queue to a second pod request queue. In optional block 512, the comparison compares a first pod request queue length with a second pod request queue length. Other types of comparison are also contemplated based on the marking from block 508. For example, if there is a prioritization marking on the request, then the comparison is of priority, and the highest/higher priority request is executed sooner. In block 514, the more than one request is executed. In optional block 516, the transfer of block 510 causes the system to have a reduced overall execution time, overall lower latency, overall lower run time, overall higher throughput, etc. In alternative embodiments of the present invention, the improvement can affect a portion of the execution time, lower latency, lower run time, higher throughput, etc. In optional block 518 and optional block 520 a response of execution is sent. The response can be a notification. In block 518, in response to the more than one request originating from the first pod request queue, sending a response to a client. In block 520, in response to the more than one request originating from the second pod request queue, sending a response to a second pod, which can then subsequently send a response to the client.

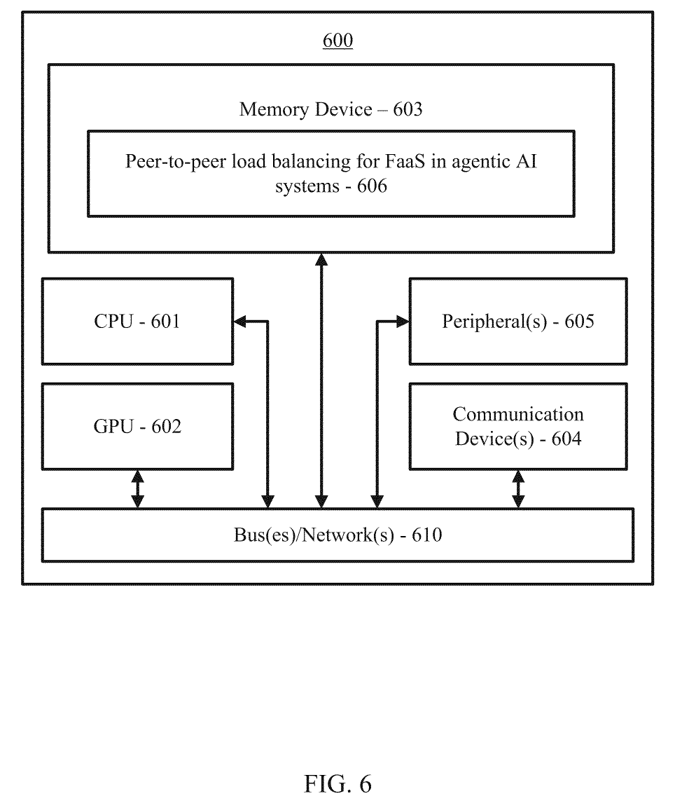

Referring to FIG. 6, a block diagram is shown for an exemplary processing system 600, in accordance with an embodiment of the present invention. The processing system 600 includes a set of processing units (e.g., CPUs) 601, a set of GPUs 602, a set of memory devices 603, a set of communication devices 604, and a set of peripherals 605. CPUs 601 can be single or multi-core CPUs. The GPUs 602 can be single or multi-core GPUs. The one or more memory devices 603 can include caches, RAMs, ROMs, and other memories (flash, optical, magnetic, etc.). The communication devices 604 can include wireless and/or wired communication devices (e.g., network (e.g., Wi-Fi®, etc.) adapters, etc.). The peripherals 605 can include a display device, a user input device, a printer, an imaging device, and so forth. Elements of processing system 600 are connected by one or more buses or networks (collectively denoted by the figure reference numeral 610).

In an embodiment of the present invention, memory devices 603 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 603 store program code or software 606 for peer-to-peer load balancing. The load balancing software 606 further includes prompting a model to develop a workflow, the workflow includes a set of separate component operations that can be executed as more than one request on more than one pod and queueing the more than one request for execution on the more than one pod. Software 606 further includes comparing a first pod request queue with a second pod request queue, and in response to the comparison, transferring one of the more than one request from a first pod request queue to a second pod request queue and executing the more than one request. The memory devices 603 can store program code for implementing one or more functions of the systems and methods described herein.

Of course, the processing system 600 may also include other elements (not shown), as readily contemplated by one of skill in the art, as well as omitting certain elements. For example, various other input devices and/or output devices can be included in processing system 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 600.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
prompting a model to develop a workflow, the workflow including a set of component operations that can be executed as more than one request on more than one pod;
queueing the more than one request for execution on the more than one pod;
comparing a first pod request queue with a second pod request queue, and in response to the comparison, transferring one of the more than one request from a first pod request queue to a second pod request queue; and
executing the more than one request.

2. The method of claim 1, wherein the comparison includes comparing a first pod request queue length with a second pod request queue length.

3. The method of claim 1, wherein the transfer reduces an overall execution time of the workflow.

4. The method of claim 1, further comprising:
in response to the more than one request originating from the first pod request queue, sending a response to a client.

5. The method of claim 1, further comprising:
in response to the more than one request originating from the second pod request queue, sending a response to a second pod.

6. The method of claim 1, further comprising:
creating service objects which allow access to a hypertext transfer protocol (HTTP) endpoint of the more than one request; and
creating deployment objects for allowing management of a life-cycle of the more than one pod.

7. The method of claim 1, further comprising:
timestamping the more than one request, wherein the more than one request with an earliest timestamp is executed in each pod.

8. A system, comprising:
a processor; and
a memory storing computer-readable instructions that, when executed by the processor, cause the processor to:
prompt a model to develop a workflow, the workflow includes a set of component operations that can be executed as more than one request on more than one pod;
queue the more than one request for execution on the more than one pod;
compare a first pod request queue with a second pod request queue, and in response to the comparison, transferring one of the more than one request from a first pod request queue to a second pod request queue; and
execute the more than one request.

9. The system of claim 8, wherein the comparison includes comparing a first pod request queue length with a second pod request queue length.

10. The system of claim 8, wherein the transfer reduces an overall execution time of the workflow.

11. The system of claim 8, further causes the processor to:
in response to the more than one request originating from the first pod request queue, send a response to a client.

12. The system of claim 8, further causes the processor to:
in response to the more than one request originating from the second pod request queue, send a response to a second pod.

13. The system of claim 8, further causes the processor to:
create service objects which allow access to a hypertext transfer protocol (HTTP) endpoint of the more than one request; and
create deployment objects for allowing management of a life-cycle of the more than one pod.

14. The system of claim 8, further causes the system to:
timestamp the more than one request, wherein the more than one request with an earliest timestamp is executed in each pod.

15. A computer program product comprising a non-transitory computer-readable storage medium containing computer program code, the computer program code when executed by one or more processors causes the one or more processors to perform operations, the computer program code comprising instructions to:
prompt a model to develop a workflow, the workflow includes a set of component operations that can be executed as more than one request on more than one pod;
queue the more than one request for execution on the more than one pod;
compare a first pod request queue with a second pod request queue, and in response to the comparison, transferring one of the more than one request from a first pod request queue to a second pod request queue; and
execute the more than one request.

16. The computer program product of claim 15, wherein the comparison includes comparing a first pod request queue length with a second pod request queue length.

17. The computer program product of claim 15, wherein the transfer reduces an overall execution time of the workflow.

18. The computer program product of claim 15, wherein the instructions further cause the one or more processors to:
in response to the more than one request originating from the first pod request queue, send a response to a client.

19. The computer program product of claim 15, wherein the instructions further cause the one or more processors to:
in response to the more than one request originating from the second pod request queue, send a response to a second pod.

20. The computer program product of claim 15, wherein the instructions further cause the one or more processors to:
create service objects which allow access to a hypertext transfer protocol (HTTP) endpoint of the more than one request; and
create deployment objects for allowing management of a life-cycle of the more than one pod.
